(19) United States
(12) Patent Application Publication
(10) Pub. No.: US 2026/0067780 A1
(43) Pub. Date: Mar. 5, 2026

(54) HANDOVER METHOD BASED ON LOCATION INFORMATION

(71) Applicants: HYUNDAI MOTOR COMPANY, Seoul (KR); KIA CORPORATION, Seoul (KR)

(72) Inventors: Il-Do Jung, Hwaseong-si (KR); Jin-Seok Kim, Hwaseong-si (KR); Ji-Hoon Park, Hwaseong-si (KR); Sung-Huy Kim, Hwaseong-si (KR)

(73) Assignees: HYUNDAI MOTOR COMPANY, Seoul (KR); KIA CORPORATION, Seoul (KR)

(21) Appl. No.: 19/225,659

(22) Filed: Jun. 2, 2025

(30) Foreign Application Priority Data
Aug. 27, 2024 (KR) 10-2024-0115069

(51) Int. Cl. H04W 36/32; H04W 36/30

(52) U.S. Cl. CPC H04W 36/322; H04W 36/302; H04W 36/324

(57) ABSTRACT

A method of adjusting handover-related parameters includes: collecting, by a terminal management server, current location information from two or more mobile terminals and generating predicted movement path information for the two or more mobile terminals; determining, by an infrastructure management server, a predicted number of mobile terminals connected to each of two or more base stations which correspond to the predicted movement path information for each of the two or more mobile terminals; and adjusting, by the infrastructure management server, a handover-related parameter for a base station, among the two or more base stations, based on the number of mobile terminals actually connected to the base station of the two or more base stations and the predicted number of mobile terminals.

### CROSS-REFERENCE TO RELATED APPLICATION

This application claims priority to Korean Patent Application No. 10-2024-0115069, filed on Aug. 27, 2024, the entire contents of which are incorporated herein by reference.

### BACKGROUND

### Field

The present disclosure relates to a handover technology, and more specifically, to a method of adjusting handover-related parameters and executing handover.

### Description of Related Art

Fifth generation mobile communication (5G) aims for large capacity, ultra-high speed, and ultra-low delay wireless communication, and ultra-connectivity. A 5G environment is characterized by using “small cell technology”to process a huge amount of data.

Unlike a macro cell which generally supports a wideband coverage of several kilometers, the small cell is composed of a small base station with low transmission power and narrow coverage (about 10 to several hundred meters).

However, as the size of the cell is limited, the (e.g., importance of the) action of reallocating cells for communication of mobile terminals with mobility (e.g., as the mobile terminals move) increases. The action of reallocating cells due to such mobility or movement of the mobile terminals is called handover.

In such conventional 5G networks, since a location of a mobile terminal cannot be accurately predicted, handover is performed using a fixed value obtained by comparing a signal strength of a target base station with a current base station.

In such an environment, at specific points at which logistics are loaded or moved, symptoms of mobile terminal connections being crowded repeatedly occur, and a problem of unstable wireless communication quality at the corresponding point occurs.

In addition, a symptom of repeated non-operation is caused by performing handover at points at which high-speed movement is required.

In particular, such a fixed handover method for general users has a disadvantage of being unsuitable for production networks.

The statements in this Background section merely provide background information related to the present disclosure and may not constitute prior art.

### SUMMARY

Various aspects of the present disclosure have been proposed to solve the above problems and are directed to providing a method of adjusting handover-related parameters (e.g., a signal strength of a base station, a handover offset, and the like) based on location information in an indoor wireless network environment and executing handover.

In addition, various aspects of the present disclosure are directed to providing a method of improving quality of wireless communication by automatically adjusting handover-related parameters.

To achieve the above object, the present disclosure provides a method of adjusting handover-related parameters based on location information in an indoor wireless network environment and executing handover.

The method includes: collecting, by a terminal management server, current location information from two or more mobile terminals and generating predicted movement path information for the two or more mobile terminals; determining, by an infrastructure management server, a predicted number of mobile terminals connected to each of two or more base stations which are associated with or correspond to the predicted movement path information for each of the two or more mobile terminals; and adjusting, by the infrastructure management server, a handover-related parameter for a base station, among the two or more base stations, based on the number of mobile terminals actually connected to the base station and predicted number mobile terminals.

In this case, the handover-related parameter includes a base station output signal strength and a handover offset value.

In addition, adjusting the parameter includes adjusting, by the infrastructure management server, the base station output signal strength for the base station, and adjusting, by the infrastructure management server, the handover offset value for the base station.

In addition, the adjusting the base station output signal strength includes determining whether the base station output signal strength is greater than a first preset value, and sequentially reducing the base station output signal strength when the base station output signal strength is greater than the first preset value.

In addition, adjusting the handover offset value is executed based on the base station output signal strength being less than or equal to the first preset value.

In addition, reducing the base station output signal strength includes confirming whether the number of mobile terminals actually connected to the base station is within a predetermined number of the number of mobile terminals predicted as connected to the base station after sequentially reducing the base station output signal strength; and maintaining, by the base station, current handover parameter settings when the number of mobile terminals actually connected to the base station is within a predetermined number of the number of mobile terminals predicted as connected to the base station.

In addition, adjusting the handover offset value includes determining whether the handover offset value is less than a second preset value, and sequentially adjusting the handover offset value when the handover offset value is less than the second preset value.

In addition, the sequentially adjusting of the handover offset value includes confirming whether the number of mobile terminals actually connected to the base station is within a predetermined number of the number of mobile terminals predicted as connected to the base station after adjusting the handover offset value, and maintaining, by the base station, current handover parameter settings when the number of mobile terminals actually connected to the base station is within a predetermined number of the number of mobile terminals predicted as connected to the base station.

In addition, the handover offset value is set with a neighboring base station which is one of the two or more base stations neighboring the base station.

In addition, the adjusting of the handover-related parameter includes maintaining, by the specific base station, current handover parameter settings when the number of mobile terminals actually connected to the base station is less than or equal to the number of mobile terminals predicted as connected to the base station.

In addition, the number of mobile terminals actually connected is an average number of mobile terminals connected to the base station over a predetermined period of time.

According to the present disclosure, it is possible to provide optimized handover by adjusting the handover-related parameters based on location information in the indoor wireless network environment.

In addition, according to the present disclosure, it is possible to provide optimized handover to production networks.

### BRIEF DESCRIPTION OF THE DRAWINGS

FIG. 1 is a block diagram of a configuration of a wireless network according to one embodiment of the present disclosure.

FIG. 2 is a block diagram of a specific configuration of a terminal management server illustrated in FIG. 1.

FIG. 3 is a block diagram of a specific configuration of an infrastructure management server illustrated in FIG. 1.

FIG. 4 is a block diagram of a specific configuration of a base station illustrated in FIG. 1.

FIG. 5 is a flowchart illustrating a process of adjusting handover-related parameters according to one embodiment of the present disclosure.

FIG. 6 is a result table illustrating the result of measuring a speed when traffic of a plurality of mobile terminal according to one embodiment of the present disclosure is simultaneously applied.

FIG. 7 is a conceptual diagram illustrating non-occurrence of overlap according to one embodiment of the present disclosure.

FIG. 8 is a conceptual diagram illustrating occurrence of overlap according to one embodiment of the present disclosure.

The drawings described herein are for illustration purposes only and are not intended to limit the scope of the present disclosure in any way.

### DETAILED DESCRIPTION

The above-described objects, features, and advantages are described below in detail with reference to the accompanying drawings. Thus those of ordinary skill in the art to which the present disclosure pertains should be able to easily carry out the technical spirit of the present disclosure. In describing the present disclosure, when it has been determined that a detailed description of the known technology related to the present disclosure may unnecessarily obscure the gist of the present disclosure, a detailed description thereof has been omitted.

Hereinafter, several embodiments according to the present disclosure are described in detail with reference to the accompanying drawings. In the drawings, the same reference numerals are used to denote the same or similar components. When a component, device, element, or the like of the present disclosure is described as having a purpose or performing an operation, function, or the like, the component, device, or element should be considered herein as being “configured to” meet that purpose or perform that operation or function.

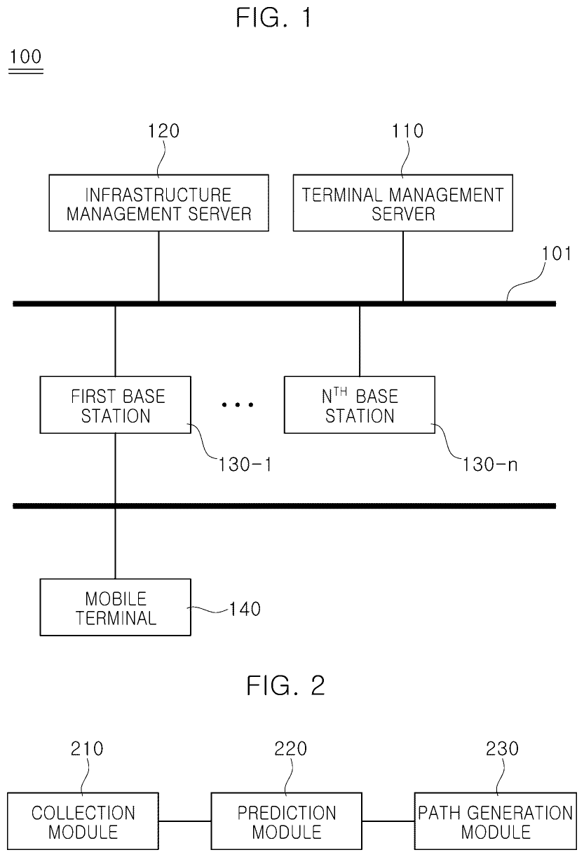

FIG. 1 is a block diagram of a configuration of a wireless network 100 according to one embodiment of the present disclosure. Referring to FIG. 1, the wireless network 100 may include an internal wired network 101, a terminal management server 110, an infrastructure management server 120, a plurality of base stations 130-1 to 130-n, one or more mobile terminals 140, and the like.

The internal wired network 101 serves to communicatively connect the terminal management server 110, the infrastructure management server 120, and the base stations 130-1 to 130-n. Accordingly, the internal wired network 101 may be a public switched telephone network (PSTN), a public switched data network (PSDN), an integrated services digital network (ISDN), a broadband ISDN (BISDN), a local area network (LAN), a metropolitan area network (MAN), a wide LAN (WLAN), or the like.

The terminal management server 110 serves to manage the one or more mobile terminals 140. The terminal management server 110 collects location information, terminal information, and the like from the one or more mobile terminals 140 and generates predicted movement path information of the respective mobile terminal(s) 140. In addition, the terminal management server 110 serves to control the path and/or operation of the one or more mobile terminals 140.

The infrastructure management server 120 serves to receive predicted movement path information of the one or more mobile terminals 140 from the terminal management server 110. Additionally, the infrastructure management server 120 serves to calculate the predicted number of mobile terminals 140 to be connected to each of the base stations 130-1 to 130-n according to the respective predicted movement paths of the mobile terminals 140. In other words, the infrastructure management server 120 calculates the number of mobile terminals 140 that are to be connected to the respective base stations 130-1 to 130-n based on the respective predicted movement paths of the mobile terminals 140.

Once the predicted number of connected terminals is calculated, the infrastructure management server 120 adjusts handover-related parameters for a base station with a large number of predicted connected mobile terminals 140. The handover-related parameters may include a base station output signal strength, a handover offset value, and the like. After adjustment of the handover-related parameter(s), the base station may operate and/or perform mobile terminal handover with or using the adjusted parameter(s).

The base station output signal strength is a signal strength which increases the probability that a mobile terminal 140 will be connected to the corresponding base station. Accordingly, when the base station output signal strength is decreased, the probability of connection is decreased, and when the base station output signal strength is increased, the probability of connection is increased.

The handover offset is a technology of applying a predetermined offset value to transfer a mobile terminal 140 being serviced to a counterpart or another base station faster or slower by applying an offset when transferring the mobile terminal 140.

Accordingly, the infrastructure management server 120 serves to (e.g., primarily) adjust the base station output signal strength, which is a handover-related parameter, for a base station with a large number of connected mobile terminals 140 and (e.g., secondarily) adjust the handover offset value, which is a handover-related parameter of the base station. In other words, the infrastructure management server 120 may execute an operation of increasing the handover offset value so that handover does not easily proceed from a neighboring base station (e.g., a second base station) to a specific base station (e.g., a first base station). Alternatively, the infrastructure management server 120 may execute an operation of decreasing the handover offset value so that handover easily proceeds to the neighboring base station (e.g., second base station) in a state of decreasing the base station output signal strength for the specific base station (e.g., the first base station). The above description is provided to describe the offset concept, and the infrastructure management server 120 may be designed and/or operate differently.

The terminal management server 110 and the infrastructure management server 120 may exchange information through the internal wired network 101.

The first to n^{th} base stations 130-1 to 130-n serve to connect and facilitate communication between the mobile terminals 140 and the terminal management server 110 or between the mobile terminals 140 and the infrastructure management server 120 for a wireless communication service.

The first to n^{th} base stations 130-1 to 130-n may be installed in a factory and may be linked to a network management system (NMS) to change the handover-related parameters. The NMS is a general term for a combination of hardware and software used to monitor and manage a computer network or networks.

Each of the mobile terminals 140 may be an automated guided vehicle (AGV), an autonomous mobile robot, wireless electronic part inspection equipment, a tablet PC, a PDA, or the like. In FIG. 1, a single mobile terminal 140 is illustrated for convenience of understanding. However, a plurality of mobile terminals 140 may be provided and the mobile terminal 140 may be provided as a plurality of mobile terminals 140.

Each mobile terminal 140 may generate current location information through a location sensor configured therein or generate current location information based on quick response (QR) information. Each mobile terminal 140 may transmit the generated current location information to the terminal management server 110 and/or the infrastructure management server 120 through the base stations 130-1 to 130-n.

FIG. 2 is a block diagram of a specific configuration of the terminal management server 110 illustrated in FIG. 1. Referring to FIG. 2, the terminal management server 110 may include a collection module 210, a prediction module 220, a path generation module 230, and the like.

The collection module 210 serves to collect current location information from the one or more mobile terminals 140. To this end, the collection module 210 may include a modem, a microprocessor, a communication circuit, a memory, and the like. The memory may be configured in combination of non-volatile memories, such as a solid state disk (SSD), a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or volatile memories, such as a DRAM, a synchronous DRAM (SDRAM), and a double data rate-SDRAM (DDR-SDRAM).

The prediction module 220 predicts the movement path of a respective one of the mobile terminals 140 based on the collected current location information of the mobile terminal 140. Generally, in the case of an AGV, an autonomous mobile robot, and the like, a movement path is designed in advance through simulation on a controller server to perform traffic control. The AGV, the autonomous mobile robot, and the like are operated according to such a movement path. A future movement path may be predicted by using the type, current position, pre-designed movement path, and the like of the mobile terminal 140.

In addition, the mobile terminal 140 mainly serviced in the factory may identify the current location information of the mobile terminal 140 even in an interior based on light detection and ranging (LiDAR) or QR information. In addition, since the movement path is regular and the space is limited, the movement path may be identified in advance by acquiring the current location information of the mobile terminal 140.

The path generation module 230 generates predicted movement path information of the corresponding mobile terminal 140 based on the predicted movement path.

Such movement path information may be displayed on coordinates of a 3D map and an actual location map. In addition, upload data may be collected at intervals of about 10 seconds as the mobile terminal 140 moves. Status information of the mobile terminal 140 may also be displayed in color on the map in real time. In addition to the status information, the base station may be displayed as online or offline.

In FIG. 2, the prediction module 220 and the path generation module 230 are illustrated separately for convenience of understanding, but the prediction module 220 and the path generation module 230 may be configured as one module.

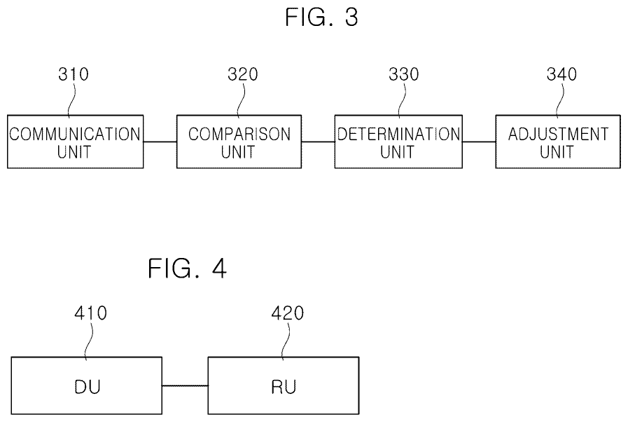

FIG. 3 is a block diagram of a specific configuration of the infrastructure management server 120 illustrated in FIG. 1. Referring to FIG. 3, the infrastructure management server 120 may include a communication unit 310, a comparison unit 320, a determination unit 330, an adjustment unit 340, and the like.

The communication unit 310 is connected to the internal wired network 101 to transmit and receive information with the terminal management server 110 and/or the first to n^{th} base stations 130-1 to 130-n. To this end, the communication unit 310 may include a communication modem, a microprocessor, a communication circuit, a memory, and the like.

The comparison unit 320 uses the predicted movement path information of the mobile terminal 140, received through the communication unit 310, to calculate the number of terminals predicted to be connected (i.e., the predicted number of mobile terminals”) to each base station along the movement path of the mobile terminal 140. Additionally, the comparison unit 320 is also configured to compare the predicted number of mobile terminals 140 connected to a specific base station (e.g., a first base station) to the actual number of mobile terminals 140 connected to the specific base station.

The determination unit 330 determines whether to adjust handover-related parameters based on the result of the comparison between the actual number of connected mobile terminals 140 and the predicted number of connected mobile terminals 140. In other words, the determination unit 330 determines whether the number of mobile terminals 140 actually connected to a specific base station (e.g., a first base station) is greater than the number of mobile terminals predicted as connected to a neighboring base station (e.g., a second base station). When the number of mobile terminals 140 actually connected to a specific base station (e.g., first base station) is greater than the predicted number of terminals connected to the neighboring base station (e.g., a second base station), it is necessary to limit the number of mobile terminals connected to the specific base station (e.g., first base station). Accordingly, the determination unit 330 compares the handover-related parameters with set values (e.g., predetermined values) and determines whether to adjust the handover-related parameters of one or both of the specific base station (e.g., first base station) and the neighboring base station (e.g., second base station).

The adjustment unit 340 adjusts the base station output signal strength of the specific base station or the handover offset value between the specific base station and the neighboring base station according to the determination of the determination unit 330.

The prediction module 220, the path generation module 230, the comparison unit 320, the determination unit 330, the adjustment unit 340, and the like illustrated in FIGS. 3 and 4 mean units for processing at least one function or operation, and these may be implemented as software and/or hardware. In implementing hardware, the hardware can be implemented as an application specific integrated circuit (ASIC) designed to perform the above-described functions, digital signal processing (DSP), a programmable logic device (PLD), a field programmable gate array (FPGA), a processor, a microprocessor, other electronic units, or a combination thereof.

In implementing software, the software may include software composition components (elements), object-oriented software composition components, class composition components and task composition components, processes, functions, attributes, procedures, subroutines, segments of program code, drivers, firmware, microcode, data, databases, data structures, tables, arrays, and variables. The software, the data, and the like may be stored in a memory and executed by a processor. The memory or the processor may adopt various means well known to those of ordinary skill in the art.

FIG. 4 is a block diagram of a specific configuration of the base station 130-1 to 130-n illustrated in FIG. 1. Referring to FIG. 4, the base stations 130-1 to 130-n may include a digital unit (DU) 410 for encrypting and decrypting a digital signal, a radio unit (RU) 420 for converting the digital signal into a radio signal according to a frequency band, and the like. The DU 410 may be configured as a channel card. The RU 420 may include a transceiver, a signal converter, an amplifier, a filter, and the like

The base stations 130-1 to 130-n may be a remote radio head (RHH). In other words, the RHH remotely separates some of the RU 420 and serves as a conventional repeater.

In addition, the base stations 130-1 to 130-n may basically predict a serviceable cell range, and thus confirm the number of mobile terminals 140 connected and transmit it as information to the infrastructure management server 120.

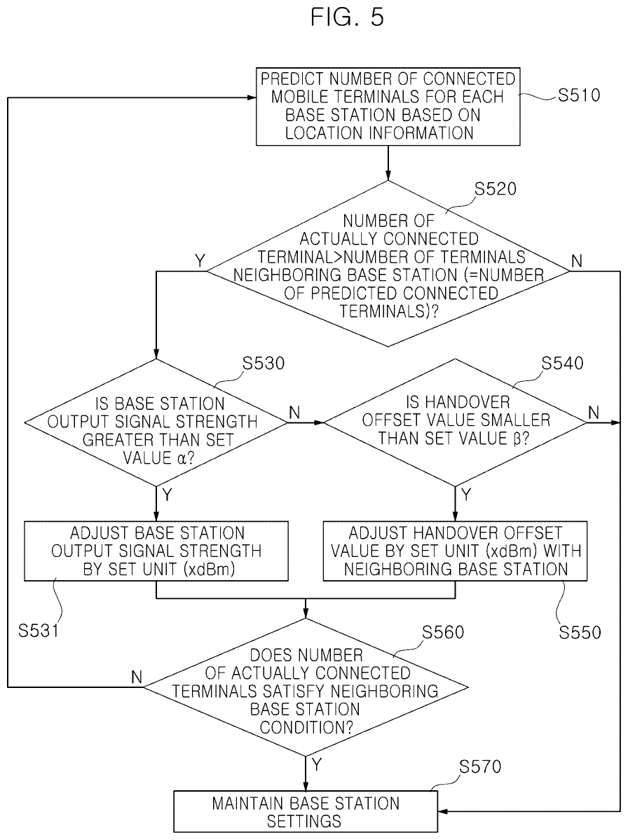

FIG. 5 is a flowchart illustrating a process of adjusting handover-related parameters according to one embodiment of the present disclosure. According to one embodiment of the present disclosure, it is possible to improve the quality of wireless communication by automatically adjusting a base station output signal strength and the handover offset value (e.g., of one or more of the base stations) in order to prevent the mobile terminals 140 from being concentrated on a specific base station by predicting the horn interference of the mobile terminals 140 without executing handover by simply setting fixed parameters of the base station.

In other words, FIG. 5 is a method of changing the handover offset for a base station based on actual collected data because there is a slight difference between the actual number of mobile terminals 140 connected to the base station on the movement path and the predicted number of mobile terminals 140 connected to the base station.

Referring to FIG. 5, the infrastructure management server 120 predicts the number of mobile terminals 140 connected to each base station based on location using the predicted movement path information from the respective mobile terminals 140, received from the terminal management server 110, and calculates the predicted number of mobile terminals 140 connected to each base station (operation S510).

In other words, the infrastructure management server 120 may calculate the predicted number of mobile terminals 140 that are to be connected to a single cell of respective base stations located along the movement paths of the mobile terminal(s) 140. The single cell is a concept referring to an area covered by one base station.

Thereafter, the infrastructure management server 120 checks whether the number of mobile terminals 140 actually connected to a specific base station (e.g., a first base station) based on the predicted movement paths of the respective mobile terminals (i.e., the actual number of mobile terminals 140 connected to the specific base station) is greater than the calculated predicted number of mobile terminals 140 (e.g., the predicted number of mobile terminals connected to a neighboring base station) (operation S520). In other words, the infrastructure management server 120 checks whether the number of mobile terminals actually connected to the specific base station (e.g., a target base station or a first base station) is satisfied with a preset number.

In other words, when a mobile terminal 140 is actually connected to the base stations 130-1 to 130-n, it is possible to determine whether a specific base station is servicing the mobile terminal 140 through a cell ID of the specific base station. Accordingly, the number of mobile terminals 140 actually connected to the specific base station may be determined using this. In this case, the number of mobile terminals 140 actually connected is the average number of mobile terminals connected to the base station for a predetermined period of time. For example, the predetermined period may be a short duration, for example, about 15 minutes. Accordingly, when an accumulated total number of mobile terminals connected to the base station during 15 minutes is divided by 15 minutes, the average number of mobile terminals 140 connected to the base station is obtained.

Referring to FIG. 5, in operation S520, when the number of terminals actually connected is less than or equal to the number of terminals predicted as connected as the result of the confirmation, the specific base station maintains the current handover parameter settings (operation S570).

In contrast, in operation S520, when the number of terminals predicted as connected is more than the number of terminals actually connected as the result of the confirmation, it is determined whether the base station output signal strength of the specific base station is greater than a set value α (operation S530).

As the result of the determination, in operation S530, when the base station output signal strength is greater than the set value α, the base station output signal strength is sequentially or gradually reduced by a set value of about 1 to 3 dBm so that another base station services more mobile terminals 140 (operation S531). In other words, when the base station output signal strength is reduced all at once, the number of connected mobile terminals 140 may be reduced, but coverage problems may occur, and thus the base station output signal strength is sequentially or gradually reduced.

Meanwhile, in operation S530, when the base station output signal strength is less than or equal to the set value α, it is determined whether the handover offset value is less than a preset set value β (operation S540). In other words, when the base station output signal strength at a specific base station is greater than a minimum output set by a user, the process moves to a base station output signal strength adjusting operation, and when the base station output signal strength is smaller than or equal to the minimum output set by the user, the process moves to a handover offset adjusting operation.

Accordingly, in operation S540, it is determined whether the handover offset value set with each neighboring base station neighboring the specific base station is smaller than the maximum threshold value β set by the user.

In operation S540, as the result of the determination, when the handover offset value is greater than or equal to the maximum threshold value β set by the user, the specific base station maintains the current handover parameter settings (operation S570).

In contrast, in operation S540, as the result of the determination, when the handover offset value is smaller than the maximum threshold value β, the handover offset value is sequentially or gradually adjusted (operation S550). In other words, the handover offset value is sequentially or gradually increased by the set value of about 1 to 3 dBm. Accordingly, handover can be quickly performed to another neighboring base station with relatively few connected mobile terminals 140.

In other words, the specific base station (e.g., first base station) and the neighboring base station (e.g., second base station) transfer a current communication channel with the connected mobile terminal 140 through a mutual handover reference value to a counterpart base station (i.e., neighboring base station). Accordingly, the handover offset value set with the base station may be set to about 3 dBm based on a Reference Signals Received Power (RSRP). Accordingly, the handover offset value between a specific base station A (e.g., first base station) and a neighboring base station B (e.g., second base station) is sequentially or gradually increased from 3 dBm->4 dBm->5 dBm.

After adjusting the base station output signal strength or the handover offset value, it is confirmed whether the number of terminals actually connected is similar to the number of terminals predicted as connected to the neighboring base station (operation S560).

As the result of the confirmation, in operation S560, when the number of terminals actually connected differs from the number of terminals predicted as connected to the neighboring base station, operations S510-S560 are performed.

In contrast, in operation S560, when the number of terminals actually connected is the same as the number of terminals predicted as connected to the neighboring base station, the current base station settings are maintained (operation S570).

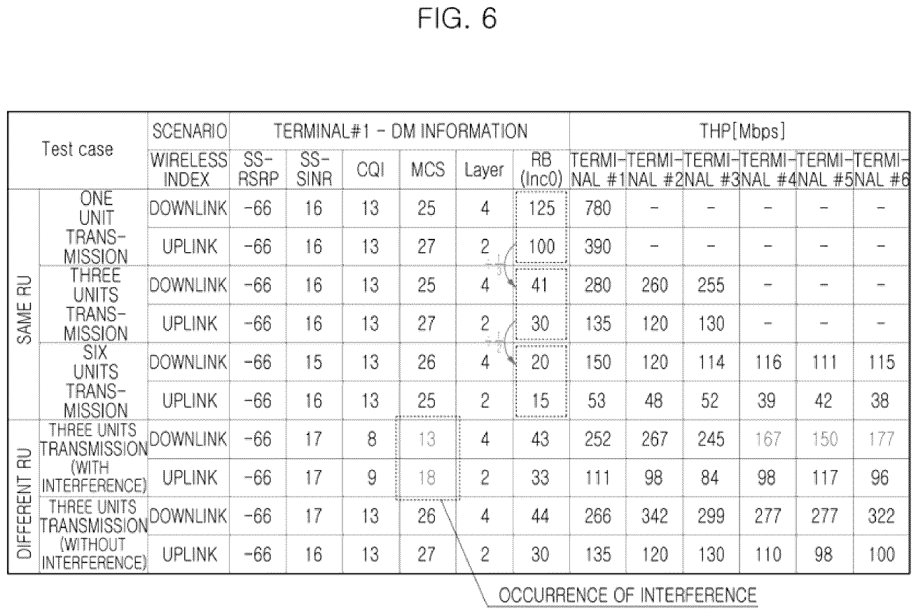

FIG. 6 is a result table illustrating the result of measuring a speed when traffic of a plurality of mobile terminals according to one embodiment of the present disclosure are simultaneously applied. Referring to FIG. 6, since resource block (RB) resources are shared within the same RU, a speed is reduced by the number of transmitting mobile terminals. In other words, a transmission speed is reduced to about 1/N. Here, N denotes the number of mobile terminals. In other words, since resources are shared and used, there is no interference in the same RU.

Meanwhile, since mobile terminals serving different RUs use resources in the same area, interference may occur in an overlapping area. Accordingly, a modulation and coding selection (MCS) degradation phenomenon due to interference occurs. Of course, since RUs without overlapping areas are completely independently operated even if they are connected to the same DU, the RUs do not affect each other.

In FIG. 6, DM refers to demodulation, SS-RSRP refers to synchronization signal-reference signal received power, SS-SINR refers to synchronization signal-to-interference-plus-noise ratio, CQI refers to channel quality indicator/indication, and THP refers to throughput and means the amount of data transmitted through the network per unit time.

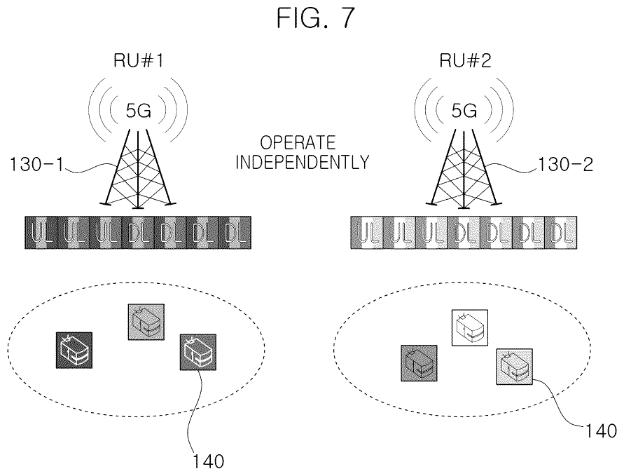

FIG. 7 is a conceptual diagram illustrating non-occurrence of overlap according to one embodiment of the present disclosure. FIG. 7 illustrates a state in which no overlap occurs between a first base station 130-1 and a second base station 130-2. In other words, a first RU #1 and a second RU #2 operate independently of each other.

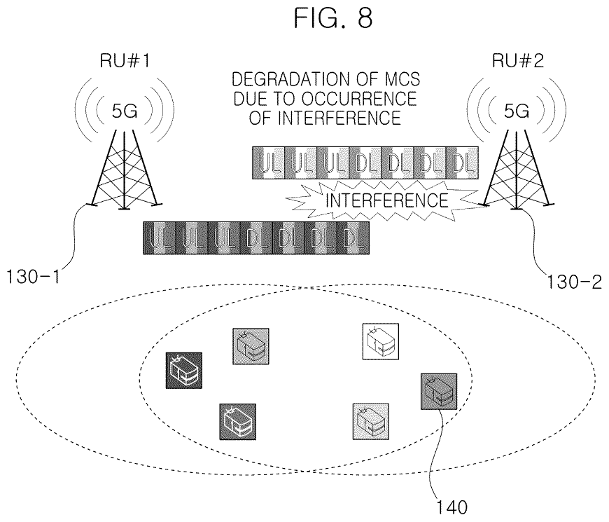

FIG. 8 is a conceptual diagram illustrating occurrence of overlap according to one embodiment of the present disclosure. FIG. 8 illustrates a state in which overlap occurs between the first base station 130-1 and the second base station 130-2. In other words, interference occurs between the first RU #1 and the second RU #2, and the MCS is degraded.

In addition, the operations of the method or algorithm described in relation to the embodiments disclosed herein may be implemented in the form of program commands that may be executed through various computer devices such as a microprocessor, a processor, and a central processing unit (CPU) and stored in a computer-readable medium. The computer-readable medium may include program (command) codes, data files, data structures, etc. alone or in combination.

What is claimed is:

1. A handover method based on location information, the handover method comprising:
collecting, by a terminal management server, current location information from two or more mobile terminals and generating predicted movement path information for the two or more mobile terminals;
determining, by an infrastructure management server, a predicted number of mobile terminals connected to each of two or more base stations corresponding to the predicted movement path information for each of the two or more mobile terminals; and
adjusting, by the infrastructure management server, a handover-related parameter for a base station, among the two or more base stations, based on a number of mobile terminals actually connected to the base station and the predicted number of mobile terminals.

2. The handover method of claim 1, wherein the handover-related parameter includes a base station output signal strength and a handover offset value.

3. The handover method of claim 2, wherein the adjusting of the parameter includes:
adjusting, by the infrastructure management server, the base station output signal strength for the base station; and
adjusting, by the infrastructure management server, the handover offset value for the base station.

4. The handover method of claim 3, wherein adjusting the base station output signal strength includes:
determining whether the base station output signal strength is greater than a first preset value; and
sequentially reducing the base station output signal strength based on the base station output signal strength being greater than the first preset value.

5. The handover method of claim 4, wherein adjusting the handover offset value is executed based on the base station output signal strength being less than or equal to the first preset value.

6. The handover method of claim 4, wherein reducing the base station output signal strength includes:
confirming whether the number of mobile terminals actually connected to the base station is within a predetermined number of the number of mobile terminals predicted as connected to the base station after sequentially reducing the base station output signal strength; and
maintaining, by the base station, current handover parameter settings based on the number of mobile terminals actually connected to the base station being within a predetermined number of the number of mobile terminals predicted as connected to the base station.

7. The handover method of claim 3, wherein adjusting the handover offset value includes:
determining whether the handover offset value is less than a second preset value; and
sequentially adjusting the handover offset value based on the handover offset value being less than the second preset value.

8. The handover method of claim 7, wherein the sequentially adjusting of the handover offset value includes:
confirming whether the number of mobile terminals actually connected is within a predetermined number of the number of mobile terminals predicted as connected to the base station after adjusting of the handover offset value; and
maintaining, by the base station, current handover parameter settings based on the number of mobile terminals actually connected being within a predetermined number of the number of mobile terminals predicted as connected to the base station.

9. The handover method of claim 3, wherein the handover offset value is set with a neighboring base station which is one of the two or more base stations neighboring the base station.

10. The handover method of claim 1, wherein adjusting the handover-related parameter includes maintaining, by the base station, current handover parameter settings based on the number of mobile terminals actually connected to the base station less than or equal to the number of mobile terminals predicted as connected to the base station.

11. The handover method of claim 1, wherein the number of mobile terminals actually connected is an average number of mobile terminals connected to the base station over a predetermined period of time.
